(19) United States
(12) Patent Application Publication
(10) Pub. No.: US 2018/0128785 A1
(43) Pub. Date: May 10, 2018

(54) INTERFACE FOR A MEASURING TRANSDUCER

(71) Applicant: Endress+Hauser Conducta GmbH+Co. KG, Gerlingen (DE)

(72) Inventor: Axel Vierkötter, Renningen (DE)

(21) Appl. No.: 15/791,608

(22) Filed: Oct. 24, 2017

(30) Foreign Application Priority Data
Nov. 4, 2016 (DE) 10 2016 121 105.2

(51) Int. Cl. G01N 29/44; G01N 29/28; G01N 29/24

(52) U.S. Cl. CPC G01N 29/44; G01N 2291/101; G01N 29/2443; G01N 29/28

(57) ABSTRACT

The present disclosure relates to an interface for a measuring transducer for receiving and processing measured data, comprising an input, an output, and an acoustic coupler having an acoustic transmitter and an acoustic receiver, wherein the acoustic transmitter and the acoustic receiver are acoustically coupled to each other, wherein the acoustic transmitter is connected to the input, and the acoustic receiver is connected to the output, such that the input is galvanically isolated from the output.

### CROSS-REFERENCE TO RELATED APPLICATION

The present application is related to and claims the priority benefit of German Patent Application No. 10 2016 121 105.2, filed on Nov. 4, 2016, the entire contents of which are incorporated herein by reference.

### TECHNICAL FIELD

The present disclosure relates to an interface for a measuring transducer for receiving and processing measured data, and a corresponding measuring transducer.

### BACKGROUND

Measuring transducers are used in all areas of industrial measurement technology. They typically serve to convert one or more physical variables measured by sensors connected thereto into electrical output signals that reproduce the measured variables, and to transmit these signals via an output unit such as a current output or a communication unit, such as a bus interface, to a higher-level unit such as a process control system.

For the industrial use of such measuring transducers, today, it is regularly stipulated for safety reasons that the individual units must be galvanically isolated from each other and from the energy supply of the measuring transducer.

To accomplish this, a number of galvanic isolations is needed that corresponds to the number of components of the respective measuring transducer. A relatively large number of these galvanic isolations must be provided in measuring transducers for multi-sensor systems with many sensors to be connected thereto and different communication and output units. The number of required components and the space required for this in the measuring transducers are correspondingly large.

### SUMMARY

The aim of the present disclosure is to present an alternative interface for a measuring transducer with galvanic isolation, and a corresponding measuring transducer.

The aim is achieved by the subject matter of the present disclosure. The subject matter of the present disclosure is an interface for a measuring transducer for receiving and processing measured data, comprising an input, an output, and an acoustic coupler with an acoustic transmitter and an acoustic receiver, wherein the acoustic transmitter and the acoustic receiver are acoustically coupled to each other, wherein the acoustic transmitter is connected to the input, and the acoustic receiver is connected to the output such that the input is galvanically isolated from the output.

Acoustic couplers are robust, wear-free components that do not manifest any signs of aging. In contrast to acoustic couplers, optocouplers manifest attenuating LED radiation power.

Moreover, acoustic couplers manifest high temperature stability that renders the acoustic couplers suitable for automotive uses. The acoustic coupling enables, in particular, individual isolation distances.

According to an advantageous development, the acoustic transmitter and the acoustic receiver are each designed as piezoelectric elements.

Acoustic couplers with piezoelectric elements are termed piezo couplers. A piezo coupler is an electronic component and serves to transmit an electrical signal between two galvanically isolated circuits. It normally consists of two piezoelectric elements; one piezoelectric element serves as a transmitter, and the other piezoelectric element serves as a receiver. The transmitter and the receiver are acoustically coupled to each other. By means of piezo couplers, both digital and analog signals can be transmitted.

Piezo sensors and actuators are used in numerous applications within the automotive industry, as well as, to a great extent, within the processing industry. At least one piezoelectric element is used in the present disclosure. A piezoelectric element is a component that exploits the piezo effect in order to either execute a mechanical movement by applying an electrical voltage, or generate an electrical voltage upon the effect of a mechanical force. In the present disclosure, both properties are combined in one component and are coupled by means of an acoustic transmission path.

According to an advantageous variant, the distance between the two piezoelectric elements is 1 mm to 10 mm.

When the acoustic isolation path between the transmitter and the receiver is less than 1 mm to about 10 mm, a correspondingly required isolation distance is ensured for the stipulated high-voltage strength.

According to an advantageous embodiment, the acoustic transmitter and the acoustic receiver are acoustically coupled to each other by means of air.

According to an advantageous embodiment, the acoustic coupler is arranged in a transducer housing.

The aim of the present disclosure is achieved by an additional item. The additional item is a measuring transducer for receiving and processing measured data comprising a transducer housing, with at least one circuit chamber in the interior of the transducer housing, and an electronic circuit, arranged in the circuit chamber and having at least one interface according to the present disclosure for supplying a sensor and for receiving and processing measured data from the sensor.

### BRIEF DESCRIPTION OF THE DRAWINGS

The present disclosure is explained in more detail based upon the following drawings. Illustrated are:

FIG. 1 shows a schematic sketch of an interface for a measuring transducer, and

FIG. 2 shows a circuit of an interface corresponding to FIG. 1.

### DETAILED DESCRIPTION

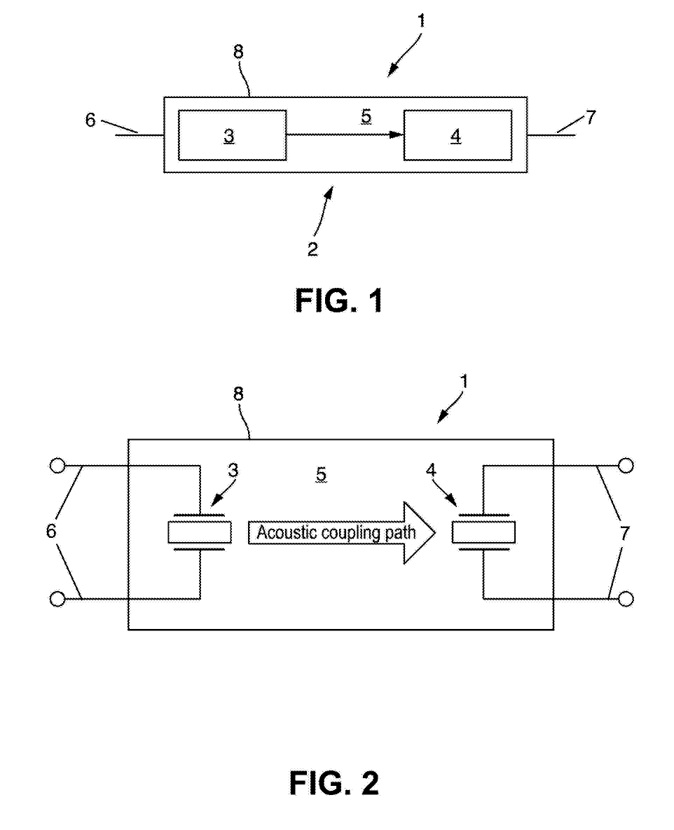

FIG. 1 shows a schematic sketch of an interface 1 for a measuring transducer (not shown) for receiving and processing measured data. The interface 1 comprises an input 6, an output 7, and an acoustic coupler 2. The acoustic coupler 2 has an acoustic transmitter 3 and an acoustic receiver 4, wherein the acoustic transmitter 3 and the acoustic receiver 4 are acoustically coupled to each other. The acoustic coupler 2, including the acoustic transmitter 3 and the acoustic receiver 4, are arranged in a transducer housing 8.

The transmission of a signal at a frequency between 300 Hz and 1 kHz was successfully transmitted by the interface. The transmission was demonstrated by an oscilloscope.

FIG. 2 shows a circuit of an interface 1 corresponding to FIG. 1. The acoustic transmitter 3 is connected to the input 6, and the acoustic receiver 4 is connected to the output 7 of the interface 1. In this manner, the input 6 is galvanically isolated from the output 7. The acoustic transmitter 3 and the acoustic receiver 4 are each designed as a piezoelectric element. The piezoelectric elements originate from two worn-out electric lighters. The piezo crystals were removed therefrom and joined at a distance of 3 mm. The structure was soldered to a part of a printed circuit board and surrounded with balsa wood, which served as the transducer housing 8.

1. An interface for a measuring transducer for receiving and processing measured data, comprising:
an input;
an output; and
an acoustic coupler having an acoustic transmitter and an acoustic receiver, wherein the acoustic transmitter and the acoustic receiver are acoustically coupled to each other, and
wherein the acoustic transmitter is connected to the input, and the acoustic receiver is connected to the output such that the input is galvanically isolated from the output.

2. The interface according to claim 1, wherein the acoustic transmitter is a piezoelectric element and the acoustic receiver is a piezoelectric element.

3. The interface according to claim 2, wherein a distance between the acoustic transmitter and the acoustic receiver is from 1 mm to 10 mm.

4. The interface according to claim 1, wherein the acoustic transmitter and the acoustic receiver are acoustically coupled to each other by air.

5. The interface according to claim 1, further comprising a transducer housing, wherein the acoustic coupler is disposed in the transducer housing.

6. A measuring transducer for receiving and processing measured data, comprising:
a transducer housing having at least one circuit chamber in the interior of the transducer housing; and
an electronic circuit disposed in the circuit chamber and having at least one interface for supplying a sensor and for receiving and processing measured data from the sensor, the interface having
an input,
an output,
an acoustic coupler having an acoustic transmitter and an acoustic receiver, wherein the acoustic transmitter and the acoustic receiver are acoustically coupled to each other, and
wherein the acoustic transmitter is connected to the input, and the acoustic receiver is connected to the output such that the input is galvanically isolated from the output.
